(19) United States
(12) Patent Application Publication
(10) Pub. No.: US 2011/0074116 A1
(43) Pub. Date: Mar. 31, 2011

(54) COLLAPSIBLE EXPANSION MECHANISM FOR EFFECTING A SEAL

(75) Inventors: Ronald W. Neuhaus, Fort Wayne, IN (US); Myron W. Worley, Middlebury, IN (US)

(73) Assignee: PRESS-SEAL GASKET CORPORATION, Fort Wayne, IN (US)

(21) Appl. No.: 12/893,485

(22) Filed: Sep. 29, 2010

Related U.S. Application Data
(60) Provisional application No. 61/246,828, filed on Sep. 29, 2009.

(51) Int. Cl. F16J 15/02; B23P 11/00

(52) U.S. Cl. 277/607; 29/428

(57) ABSTRACT

An expansion mechanism of the type that may be used with a seal for sealing a connection about the upper end of a concrete structure, such as providing as seal across a manhole frame, optionally one or more spacer rings, and the upper end of a manhole chimney or riser, or which may be used with a seal for internally sealing a connection between a pair of pipes. The expansion mechanism includes a pair of ring portions and a pair of expansion mechanisms that include pivotal connections to the ring portions such that the assembly may be moved or folded between a folded configuration, in which the assembly has a reduced profile to allow the assembly to be moved into place at the sealing site, and a deployed configuration, in which the assembly has a cylindrical shape and is expandable to compress the seal against a cylindrical surface.

### CROSS-REFERENCE TO RELATED APPLICATIONS

This application claims the benefit under Title 35, U.S.C. §119(e) of U.S. Provisional Patent Application Ser. No. 61/246,828, entitled COLLAPSIBLE EXPANSION MECHANISM FOR EFFECTING A SEAL, filed on Sep. 29, 2009, the entire disclosure of which is expressly incorporated by reference herein.

### BACKGROUND OF THE INVENTION

1. Technical Field

The present invention relates to an internal sealing assembly for sealingly connecting a pair of pipes. In one embodiment, the present invention relates to a secondary sealing assembly that can be installed within an existing pipeline about an existing pipe-to-pipe connection to seal a leak. In another embodiment, the present invention relates to a sealing assembly that can be installed within the upper end of a concrete structure, such as a manhole chimney, to provide a seal across a manhole frame, optionally one or more grade rings, and a manhole chimney to prevent moisture infiltration.

2. Description of the Related Art

Underground pipes which are used in municipal water and sewer systems, for example, typically include bell and spigot ends that are attached to one another in a sealed manner. Typically, either the spigot end or the bell end of such pipes includes a rubber seal which is compressed between the ends of the pipes to provide a sealed joint when the spigot end of one pipe is inserted into the bell end of another pipe. Occasionally, these primary joint seals between adjacent pipes may leak after installation in the field, requiring a secondary sealing assembly to seal the connection.

Manhole systems, which typically facilitate access to the underground pipes from street level, also sometimes require sealing devices. For example, the manhole chimney and riser structure, which may be metal and/or concrete tubes extending from the underground pipes, may have seams through which ground water or other surrounding fluids can seep. In some cases, it is desirable to prevent the ingress of these ambient fluids to the municipal water system through these seams in the manhole chimney.

What is needed is a sealing assembly that can be installed within the upper end of a concrete structure, such as a manhole chimney, to provide a seal across a manhole frame, optionally one or more grade rings, and a manhole chimney to prevent moisture infiltration.

What is also needed is an improved sealing assembly for sealing pipe-to-pipe joints and/or for concrete structures.

### SUMMARY OF THE INVENTION

The present invention provides an expansion mechanism of the type that may be used with a seal for sealing a connection about the upper end of a concrete structure, such as providing as seal across a manhole frame, optionally one or more spacer rings, and the upper end of a manhole chimney or riser, or which may be used with a seal for internally sealing a connection between a pair of pipes. The expansion mechanism includes a pair of ring portions and a pair of expansion mechanisms that include pivotal connections to the ring portions such that the assembly may be moved or folded between a folded configuration, in which the assembly has a reduced profile to allow the assembly to be moved into place at the sealing site, and a deployed configuration, in which the assembly has a cylindrical shape and is expandable to compress the seal against a cylindrical surface.

The present invention also provides a pipe sealing assembly for sealing a connection between a pair of pipes. The sealing assembly includes a generally cylindrical seal or gasket having a pair of axially spaced sealing portions joined by a bridge portion. Each sealing portion has a plurality of compressible sealing ridges, as well as an annular expansion band seat capable of receiving the expansion band of an expansion band assembly that is used to sealingly compress each sealing portion against a respective inner surface of a pipe. Additionally, each sealing portion may include a hollow section which houses the expansion band assembly, and may be provided with a small slit for installing the expansion band assembly and allowing access to the expansion mechanism of the expansion band assembly during installation, or a separate cover member for enclosing the expansion band assembly.

The present invention also provides a pipe sealing assembly, and a method of installing the pipe sealing assembly, for sealing a connection between a pair of underground pipes, including a generally cylindrical seal or gasket having at least three axially spaced sealing portions. Each sealing portion has a plurality of compressible sealing ridges, as well as an annular expansion band seat capable of receiving the expansion band of an expansion band assembly that is used to sealingly compress each sealing portion against a respective inner surface of a pipe. The sealing portions may include a middle sealing portion that may directly sealingly engage about, and bridge, a joint between two pipes, or may directly sealingly engage about, and bridge, a crack in a pipe. Additionally, each sealing portion may include a hollow section which houses the expansion band assembly, and may be provided with a small slit for installing the expansion band assembly. The expansion band assembly includes one or more expansion bands and one or more expansion mechanisms. The expansion bands may be initially installed as part of the pipe sealing assembly, while the expansion mechanisms may be installed after the pipe sealing assembly is brought underground through a structure, such as a manhole, and positioned at an installation site.

In one form thereof, the present invention provides a sealing assembly comprising: a cylindrical seal; and an expansion band assembly, comprising: a pair of partially-cylindrical ring portions each having opposing first and second end portions; and a pair of expansion mechanisms, each the expansion mechanism comprising: threaded first and second block members having first threads, the first block members each pivotally connected to a respective first end portion of the ring portions to define a pivot axis; and a bolt having second threads adapted to cooperate with the first threads of the first and second block members, rotation of the bolt in a first direction causing the block members to be simultaneously driven apart from one another to expand the expansion band, the ring portions pivotable with respect to one another about the pivot axes of the pair of expansion mechanisms, wherein the expansion band assembly defines a deployed configuration in which the pair of ring portions cooperate to define a substantially cylindrical shape defining an expansion band assembly diameter, and the expansion band assembly defines a collapsed configuration in which the pair of ring portions have a reduced profile smaller than the diameter.

In another form thereof, the present invention provides a sealing assembly comprising: a cylindrical seal; first and second ring portions at least partially captured within the cylindrical seal, each of the first and second ring portions comprising a first end portion having a first aperture formed therethrough, the aperture defining a first pivot axis; connecting means for pivotably connecting the first end portions of the first and second band portions to the second end portions thereof, wherein the sealing assembly is configurable in deployed and collapsed configurations, the collapsed configuration having a reduced profile as compared to the deployed configuration; and expansion means for expanding a diameter of the sealing assembly when in the deployed configuration.

In yet another form thereof, the present invention provides a method of sealing an annular wall including: providing a sealing assembly, the sealing assembly comprising: a cylindrical seal including at least one annular sealing portion, the sealing portion including an expansion band seat; and a pair of expansion band ring portions at least partially captured within the expansion band seat, the expansion band ring portions each having first and second end portions, the first end portions pivotably connected to the second end portions about a pair of pivot axes; folding the sealing assembly by pivoting the expansion band ring portions into a generally non-cylindrical configuration about the pivot axes, the step of unfolding placing the sealing assembly in a collapsed configuration; placing the sealing assembly adjacent an annular inner wall of a cylindrical structure; unfolding the sealing assembly by pivoting the expansion band ring portions into a generally cylindrical configuration, the step of unfolding placing the sealing assembly in a deployed configuration; and expanding the expansion band ring portions with respect to one another to compress the cylindrical seal against the annular inner wall of the cylindrical structure.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of a sealing assembly according to one embodiment of the present invention, shown sealing a connection between a pair of pipes;

FIGS. 2A-D are sectional views through four different embodiments of sealing assemblies according to the present invention;

FIG. 3 is a partial sectional view through a pipe joint, showing the sealing assembly of FIG. 2A installed therein;

FIGS. 4A-C are sectional views through three further embodiments of sealing assemblies according to the present invention;

FIG. 5 is a perspective view of a sealing assembly according to another embodiment of the present invention, shown sealing a connection between a pair of pipes;

FIG. 6 is sectional view through the sealing assembly, taken along line 6-6 of FIG. 5;

FIG. 7 is a first schematic perspective view of the sealing assembly of FIGS. 5 and 6, showing a user gripping the sealing assembly prior to folding same;

FIG. 8 is a second schematic perspective view of the sealing assembly, showing the user folding the sealing assembly about gap portions between ends of the expansion bands of the sealing assembly;

FIG. 9 is a perspective and sectional view of the sealing assembly being brought into an underground pipeline;

FIG. 10 is sectional view through another embodiment of a sealing assembly according to the present invention;

FIG. 11 is a schematic, multi-fragmentary view of portions of a manhole riser including the sealing assembly of FIG. 2C shown installed in the upper left portion of the drawing, and the sealing assembly of FIG. 10 shown installed in the upper right portion of the drawing, each of the sealing assemblies sealing a connection between a manhole chimney and one or more grade rings;

FIG. 12 is an enlarged, fragmentary view of an end sealing portion of the sealing assemblies of FIG. 11;

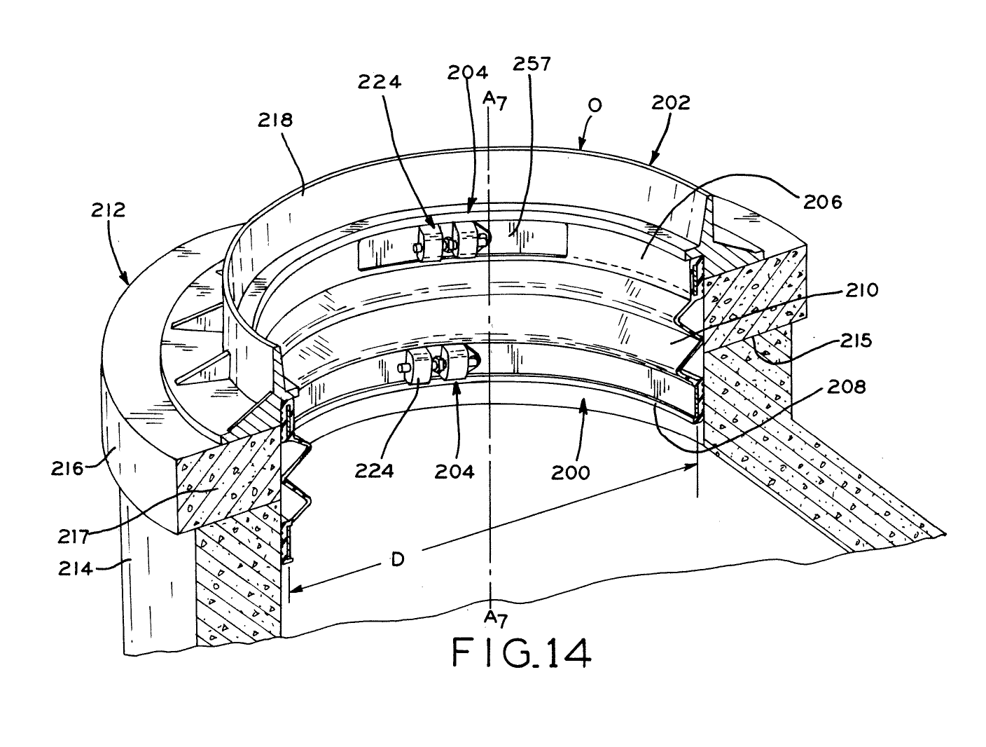

FIG. 13 is a perspective view of a sealing assembly according to a further embodiment, the sealing assembly shown in a folded configuration;

FIG. 14 is a partial sectional view of an upper portion of a concrete structure, showing the installed sealing assembly of FIG. 13;

FIGS. 15 and 16 are perspective views of the ring end portions and expansion mechanisms of the sealing assembly of FIG. 13;

FIG. 16A is a perspective view of ring end portions of the sealing assembly of FIG. 13, with an alternative expansion mechanism attached thereto;

FIGS. 17 and 18 are perspective views of the ring end portions shown in FIGS. 15 and 16;

FIG. 19 is a sectional view through a seal made in accordance with the present disclosure;

FIG. 20 is a partial, perspective view of the sealing assembly of FIG. 13, illustrating the expansion mechanism and ring end portions in the folded configuration;

FIG. 21 is perspective view of the sealing assembly of FIG. 13, illustrating a ring end portion disconnected from the expansion mechanism; and

FIG. 22 is a partial, perspective view of the sealing assembly of FIG. 21, illustrating connection of the ring end portion to the expansion mechanism.

Corresponding reference characters indicate corresponding parts throughout the several views. The exemplifications set out herein illustrate embodiments of the invention, and such exemplifications are not to be construed as limiting the scope of the invention any manner.

### DESCRIPTION OF THE INVENTION

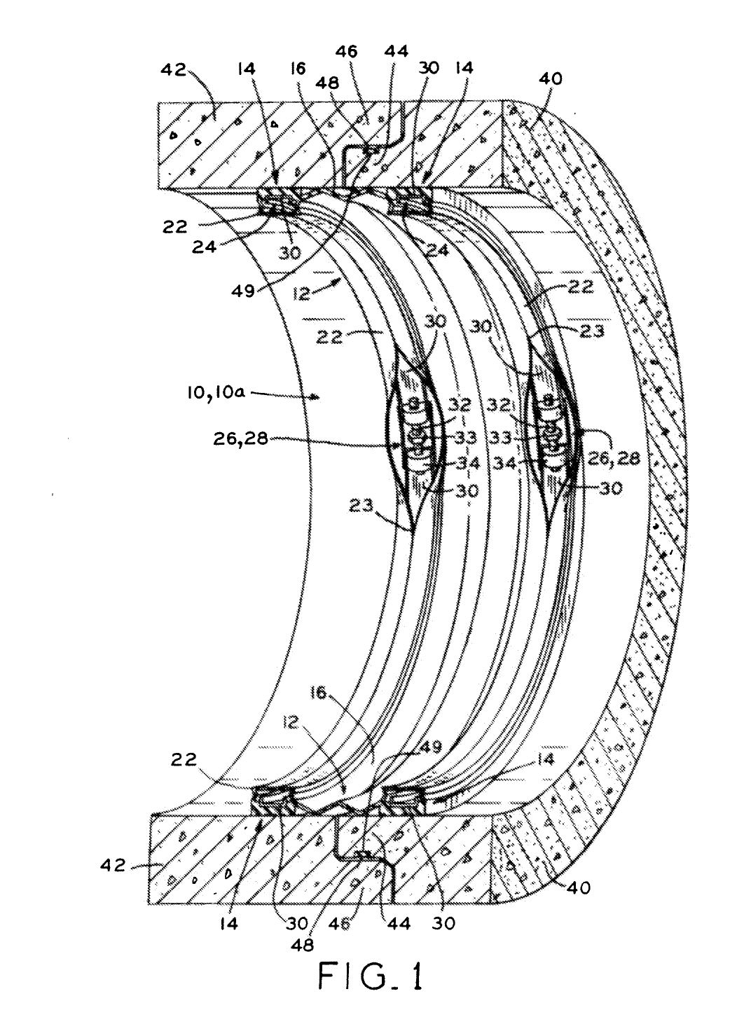

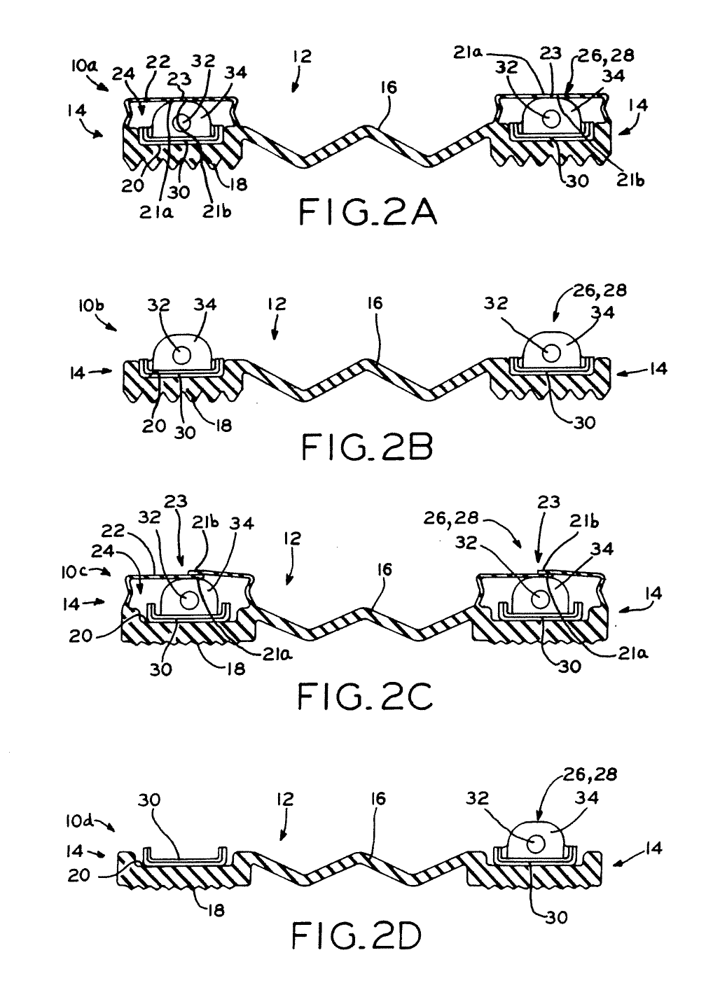

Referring to FIGS. 1 and 2A-D, four different embodiments of sealing assembly 10 of the present invention are shown. Except as discussed below, each sealing assembly 10a-10d includes a number of identical or substantially identical components, and identical reference numerals will be used throughout FIGS. 2A-D to designate identical or substantially identical components therebetween.

Each sealing assembly 10 includes a generally cylindrically shaped seal 12 having pair of axially spaced sealing portions 14 connected by a bridge portion 16. Bridge portion 16 may include one or more undulations as shown in order to permit movement of sealing portions 14 toward and away from one another along their common axis, i.e., a longitudinal axis passing through the center of seal 12. Seal 12 may be made of extruded rubber, for example, in a manner in which a length of rubber section is extruded, and then is cut to a predetermined length, followed by splicing the ends of the section together to form the cylindrical seal 12. Seal 12 may also be made of a resilient plastic material by an injection molding process, for example.

Each sealing portion 14 includes a plurality of sealing ridges 18 that are compressible against the internal surface of a pipe to provide a fluid tight seal. Additionally, each sealing portion 14 further includes an annular expansion band seat 20, shown herein as an annular recessed area of sealing portions 14, for receiving an expansion band of an expansion mechanism, as discussed below.

Additionally, as shown with respect to the embodiments of FIGS. 1, 2A and 2C, each sealing portion 14 may also be provided with a thin wall section 22 defining an annular hollow section 24 in the sealing portion 14 which accommodates the expansion band and the expansion mechanism of the expansion band assembly. As discussed below, the thin wall section 22 may include a small slit 23 for installation of the expansion band and expansion mechanism and for accessing the expansion mechanism during installation for sealingly compressing the sealing portion 12 into fluid tight engagement with the interior surface of the pipe.

Expansion band assembly 26 may be, for example, of the type disclosed in U.S. Pat. Nos. 6,805,359 and 7,146,689, each assigned to the assignee of the present invention, the entire disclosures of which are expressly incorporated herein by reference. Each expansion band assembly 26 generally includes an expansion mechanism 28 operable to expand the diameter of an expansion band 30 of the expansion band assembly 26 to radially outwardly to compress a sealing portion 14 against the inner surface of a pipe. In particular, as best shown in FIG. 1 and discussed in the above-incorporated U.S. Pat. Nos. 6,805,359 and 7,146,689, each expansion mechanism 28 generally includes a bolt 32 having oppositely-threaded ends and a central nut 33. The oppositely-threaded ends of bolt 32 are threadingly received within a pair of oppositely-threaded block members 34 which are in engagement with the opposite ends 30a and 30b of expansion band 30. In use, nut 33 of bolt 32 is engaged by a suitable tool to rotate bolt 32 and drive block members 34 apart from one another to thereby expand the diameter of expansion band 30 to radially outwardly compress a sealing portion 14 of seal 10 into tight engagement with the inner surface of a pipe.

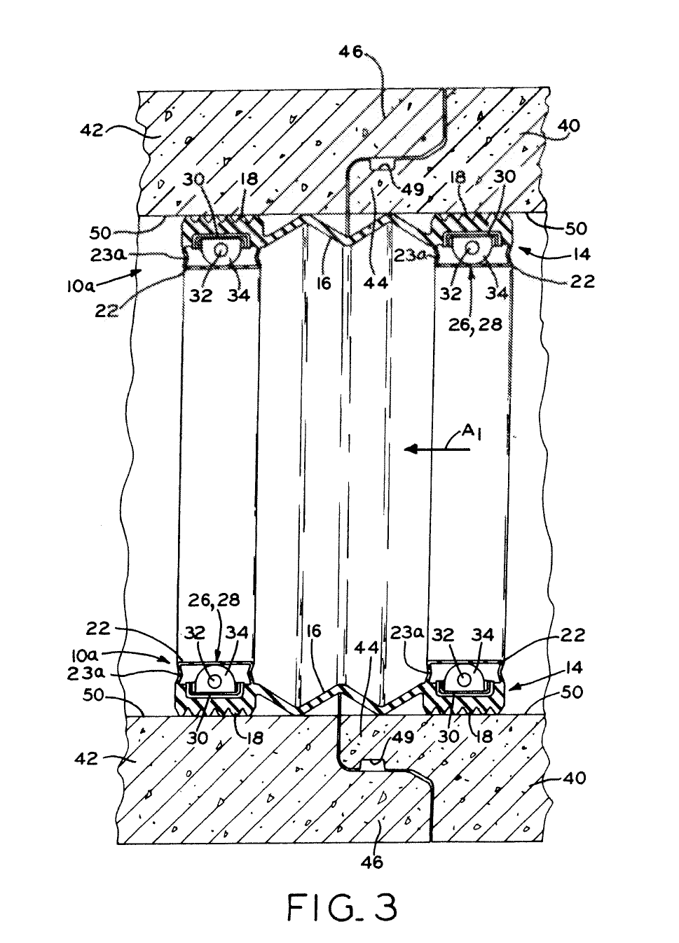

In use, referring additionally to FIG. 3 in which seal assembly 10a is shown as an example, seal assembly 10 may be used to seal a defective primary seal in a pipe-to-pipe connection between pipes 40 and 42, such as the connection between spigot end 44 of pipe 40 and socket end 46 of pipe 42 in which a primary seal 48 (FIG. 1), formed in an annular groove 49 of spigot end 44 of first pipe 40, is ineffective. Alternatively, seal assembly 10 may be used as a primary seal to seal pipes 40 and 42 upon initial connection and installation of pipes 40 and 42, or may be used to seal across a crack in pipes 40 and/or 42.

Seal 12 is placed within the pipes 40 and 42 such that one sealing portion 14 is positioned adjacent spigot end 44 of pipe 40 and the other sealing portion 14 is positioned adjacent socket end 46 of pipe section 42, with bridge portion 16 of seal 12 bridging the gap between pipes 40 and 42. Thereafter, expansion mechanisms 28 of expansion band assemblies 26 are actuated in the manner described above to outwardly radially compress sealing portions 14 and their sealing ridges 18 of seal 12 into fluid tight sealing engagement with the inner surfaces 50 of pipes, respectively, thereby providing a fluid tight seal between pipes 40 and 42.

In the embodiments in which sealing portions 14 include thin wall sections 22, one or more slits 23 may be formed, or may be cut in the field, in wall sections 22 which allow for expansion bands 30 and expansion mechanisms 28 of expansion band assembly 26 to be slidably inserted within annular hollow sections 24. The slit 23 may be disposed adjacent an expansion mechanism 28 to allow access to expansion mechanism 28 during installation to effect the seal as described above. Each slit 23 may extend around only a portion of the circumference of its wall section 22, such as around as little as 5°, 10°, or 15°, or as great as 30°, 60°, 90° or more, for example, of the circumference of wall sections 22, or alternatively, may extend around the entire circumference of wall sections 22.

The adjacent portions 21a and 21b of thin wall sections 22 defined by slits 23 may be disposed in tight abutting end-to-end contact with one another, as shown in the embodiment of FIG. 2A, for example, or may overlap one another, as shown in the embodiment of FIG. 2C, for example, in order to minimize or prevent fluid entry into hollow sections 24. Further, as shown in FIG. 3, the slits 23 may be optionally disposed on a side of sealing portions 14 opposite a direction of fluid flow along arrow A₁, such as at location 23a, for example, to minimize or prevent fluid entry into hollow sections 24. Also, the expansion mechanisms 28 may be positioned at the upper end of the pipes 40 and 42 which are normally above the fluid level of the pipes to prevent or eliminate fluid entry into hollow sections 24.

Sealing assemblies 10 for small diameter pipes, such as up to 24 inches, may include one expansion mechanism 28, while sealing assemblies 10 for larger diameter pipes, such as greater than 24 inches, may include more than one expansion mechanism 28, as needed.

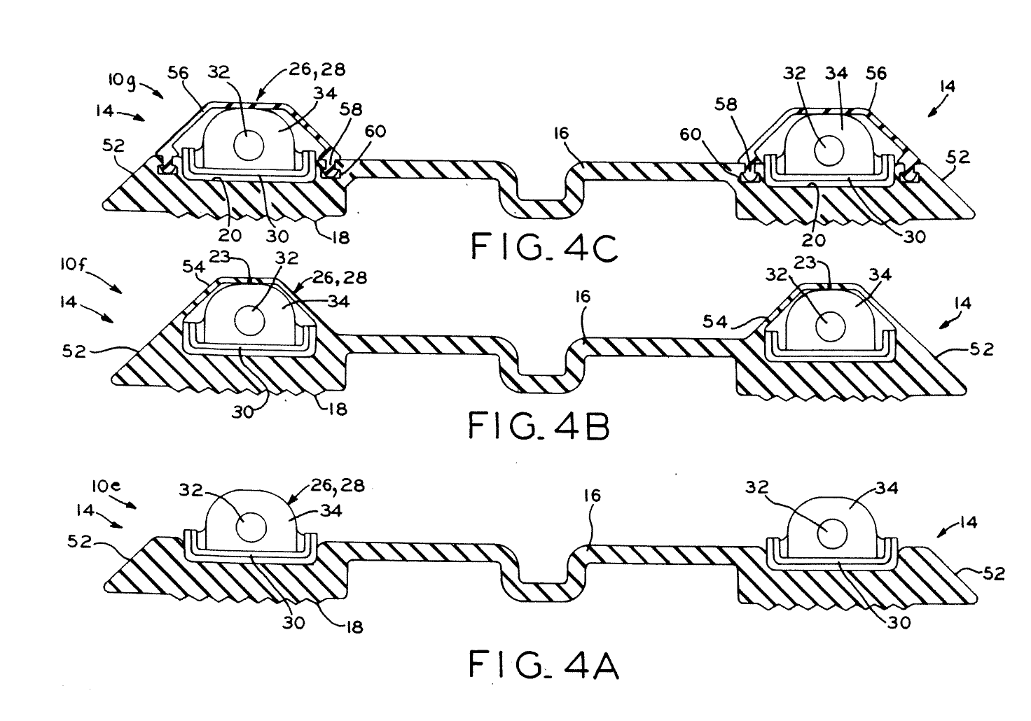

Referring to FIGS. 4A-C, sealing assemblies 10e-f according to further embodiments are shown, which, except as described above, are installed and function in the same manner as the embodiments discussed above, and identical reference numerals are used to identify identical or substantially identical components therebetween.

Sealing assembly 10e of FIG. 4A includes a ramp portion 52 at each of the ends of sealing portions 14 thereof to aid in directing a smooth or laminar flow of liquid within pipes 40 and 42 over and around the sealing assembly.

Sealing assembly 10f of FIG. 4B includes ramp portions 52 at each of the ends of sealing portions 14 thereof similar to sealing assembly 10e of FIG. 4A, and also includes thin wall sections 54 similar to thin wall sections 22 of the embodiments discussed above, wherein thin wall sections 54 are also ramped complementary with ramp portions 52 to aid in directing the flow of liquid within pipes 40 and 42 over and around the sealing assembly.

Sealing assembly 10g of FIG. 4C includes a pair of separately extruded, or otherwise separately formed, annular cover members 56 each having a pair of barbed ends 58 for snap-fitting engagement with a pair of respective grooves 60 in sealing portions 14 of sealing assembly 10g that are disposed in either side of the expansion band seats 20. Cover members 56 are also ramped complementary with ramp portions 52 to aid in directing the flow of liquid within pipes 40 and 42 over and around the sealing assembly. In use, either before or after the seal 10 of sealing assembly 10g is extruded, the expansion bands 30 and expansion mechanisms 28 are assembled in place, and an amount of adhesive, such as a liquid solvent adhesive, is applied within grooves 60 in sealing portions 14. Thereafter, barbed ends 58 of cover members 56 are snap-fitted within grooves 60 to initially retain cover members 56 in place, covering expansion bands 30 and expansion mechanisms 28 until the adhesive cures to provide a more permanent connection of cover members 56 to sealing portions 14.

Cover members 56 may also include slits, such as slits 23 described above, adjacent expansion mechanisms 28 for allowing access to expansion mechanisms during installation. Alternatively, cover members 56 that lack such slits may be secured to seal 12 in the manner described above after expansion mechanisms 28 are actuated following installation to thereby seal expansion mechanisms 28 within sealing assembly 10g in a fluid tight manner.

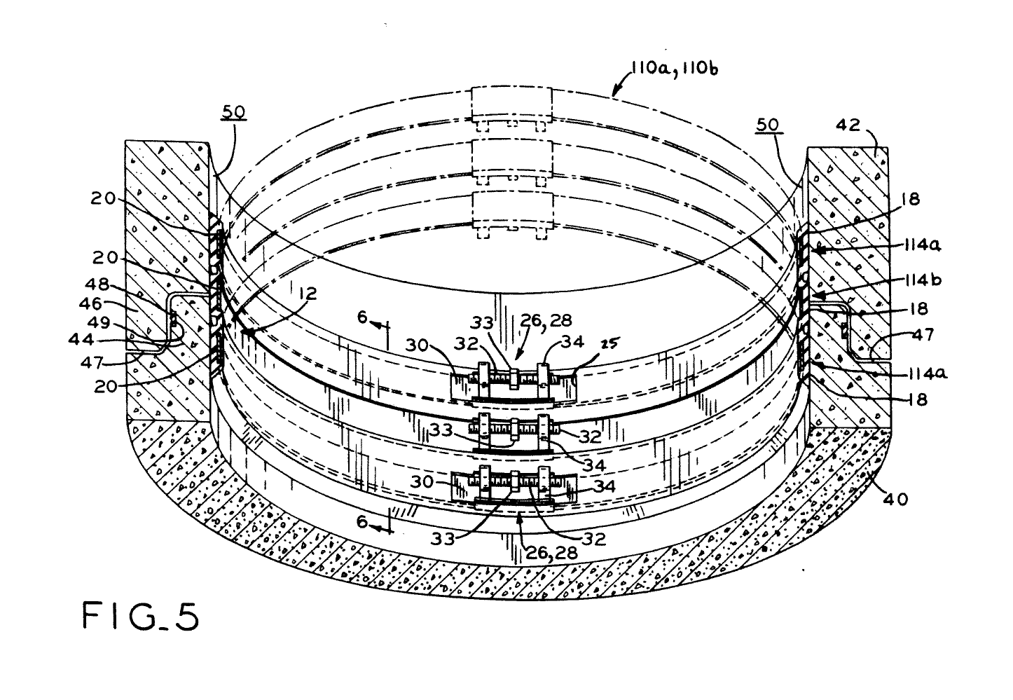

Referring to FIGS. 5-10, sealing assemblies 110a and 110b according to further embodiments are shown which, except as described below, are installed and function in the same manner as the embodiments discussed above, and identical reference numerals are used to identify identical or substantially identical components therebetween.

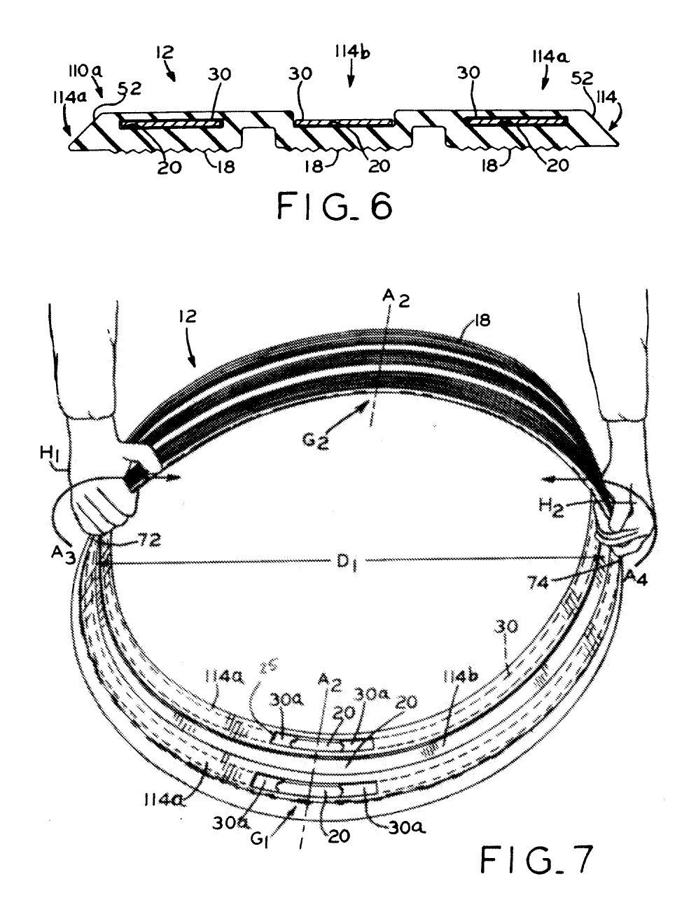

Referring now to FIGS. 5 and 6, sealing assembly 110 includes a generally cylindrically shaped seal 112 having at least three axially spaced sealing portions 114. Although the present invention will be discussed in connection with seal 112 having three axially spaced sealing portions 114, including two end sealing portions 114a and a middle sealing portion 114b, any other number of axially spaced sealing portions 114 can be used. For example, seal 112 may include four axially spaced sealing portions, including two end sealing portions 114a and two middle sealing portions 114b. Seal 112 may be made of extruded rubber, for example, in a manner in which a length of rubber section is extruded, and then is cut to a predetermined length, followed by splicing the ends of the section together to form the cylindrical seal 112. Seal 112 may also be made of a resilient plastic material by an injection molding process, for example.

Each sealing portion 114 includes a plurality of sealing ridges 18 that are compressible against the internal surface 50 of a pipe to provide a fluid tight seal. Additionally, each sealing portion 114 further includes an annular expansion band seat 20, shown herein as an annular recessed area of sealing portions 114, for receiving an expansion band 30 of an expansion band assembly 26, as discussed below.

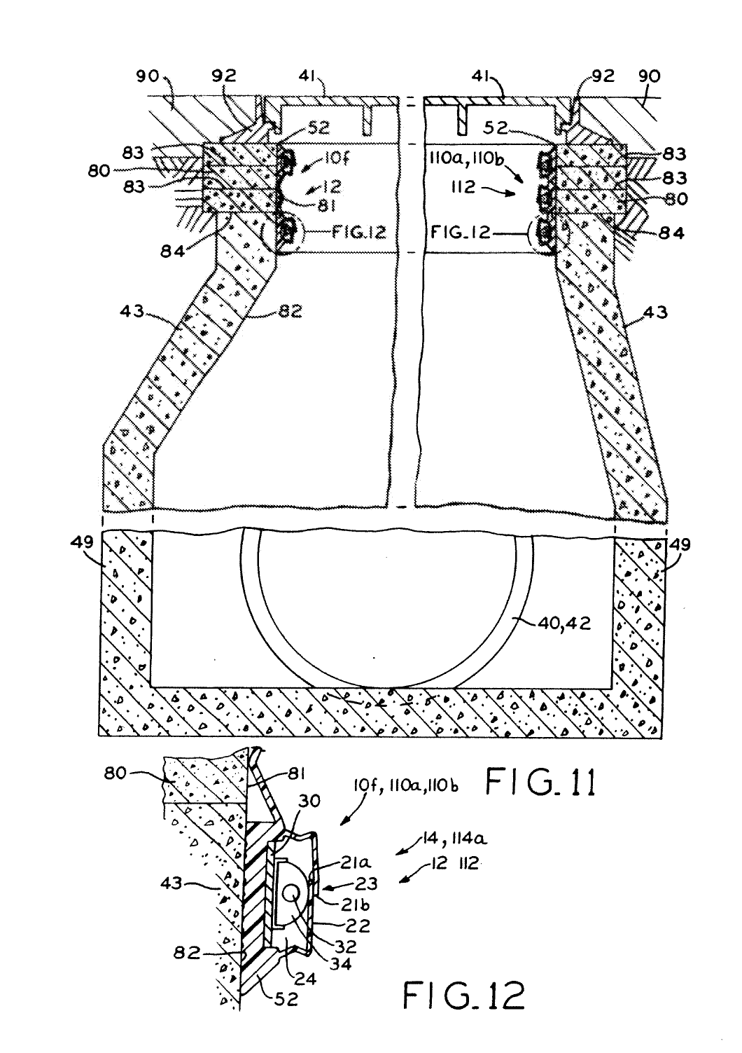

Additionally, as shown with respect to the embodiment of FIG. 10 and in the same manner as the embodiments described above, each sealing portion 114 may also be provided with a thin wall section 22 defining an annular hollow section 24 in the sealing portion 114 which accommodates the expansion band 30 and the expansion mechanism 28 of the expansion band assembly 26. As discussed below, the thin wall section 22 may include a small slit 23 or window 25 for installation of the expansion band 30 and expansion mechanism 28 and for accessing the expansion mechanism 28 during and after installation for sealingly compressing the sealing portion 112 into fluid tight engagement with the interior surface of the pipe 50.

Seal assemblies 110a and 110b of FIGS. 6 and 10, respectively, may also include a ramp portion 52 at the outside ends of the two end sealing portions 114a to aid in directing a smooth or laminar flow of liquid within pipes 40 and 42 over and around the sealing assembly.

In use, seal assembly 110 may be used to seal a defective primary seal in a pipe-to-pipe connection between pipes 40 and 42, such as the connection between spigot end 44 of pipe 40 and socket end 46 of pipe 42 in which a primary seal 48, formed in an annular groove 49 of spigot end 44 of first pipe 40, is ineffective. Alternatively, seal assembly 110 may be used as a primary seal to seal pipes 40 and 42 upon initial connection and installation of pipes 40 and 42. Seal assembly 110 may also be used as a primary or secondary seal to seal a cracked portion within one of pipes 40 and 42.

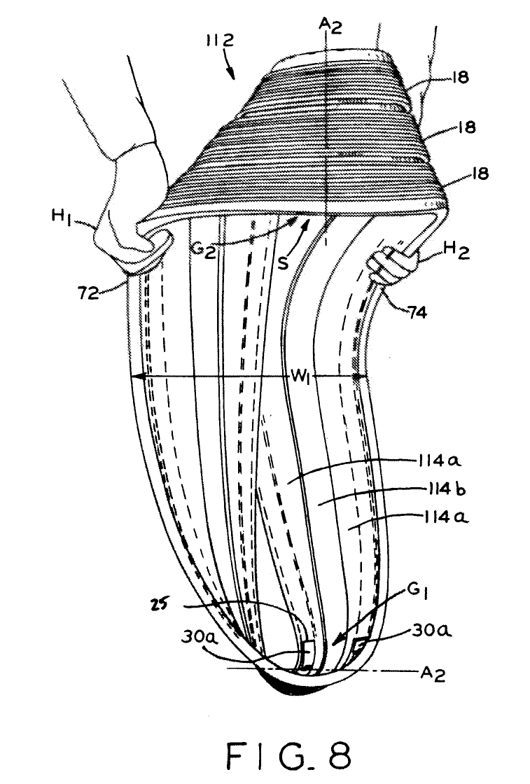

When used to seal joints and cracks in pipes that are located underground, seal assembly 110 is capable of being folded in order to easily bring seal assembly 110 through a manhole or any other type of structure to its underground installation site, as shown in FIGS. 7-9. Referring now to FIG. 7, seal 112 of seal assembly 110 is shown in an unfolded substantially annular shape and includes a diameter D₁. The diameter D₁ of seal 112 can be as little as about 12 inches, 15 inches, or 18 inches, and as large as about 72 inches, 96 inches, or 120 inches. Seal 112 includes two end sealing portions 114a and one middle sealing portion 114b. Seal 112 further includes a first side portion 72 and a second side portion 74, disposed on substantially opposing sides of seal 112 along diameter D₁, which is perpendicular to a diameter connecting gap portions G₁ and G₂, discussed below.

In this embodiment, a pair of expansion bands 30 having ends 30a are received within expansion band seats 20 of end sealing portions 114a. Expansion mechanisms 28 are not initially installed to the seal assembly 110, but rather are installed later in the installation process, as discussed below. The area of sealing portions 114 and expansion band seats 20 that is disposed between expansion band ends 30a forms a gap portion G₁ oriented along an axis A₂, which is parallel to the central longitudinal axis of seal 112. Although not visible in FIG. 7, the opposite side of seal 112 also includes the above-mentioned features, including a corresponding second gap portion G₂. Gap portions G₁ and G₂ each form an area on seal 112 with lower resistance to folding due to the absence of expansion bands 30, thus allowing seal 112 to be folded as described below for fitting through relatively small openings or access points in underground pipelines, such as manholes.

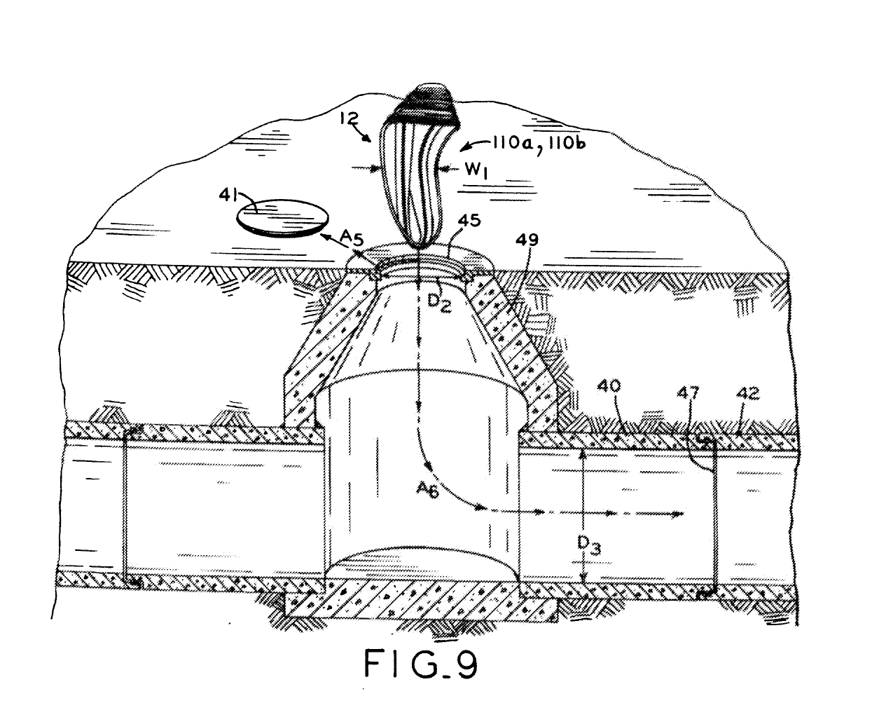

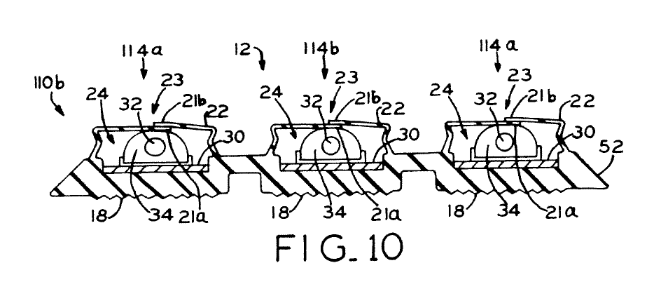

To begin the positioning and installation process, as shown in FIG. 7, a user grasps seal 112 at a first side portion 72 with a first hand H₁ and a second side portion 74 with a second hand H₂. The user then folds first side portion 72 and second side portion 74 of seal 112 toward each other in the directions of arrows A₃ and A₄, respectively, as shown in FIG. 8. This movement will allow gap portions G₁ and G₂ of seal 112 to be folded substantially about their axes A₂. As shown in FIG. 8, after folding, seal 112 will have an effective width or profile between first side portion 72 and second side portion 74, designated W₁ in FIGS. 8 and 9, that is less than its initial diameter D₁. As described above, first side portion 72 and second side portion 74, at which a user grips seal 112, do not have to directly oppose one another, so long as the user is able to fold seal 112 about gap portions G₁ and G₂ in the manner described above.

Referring now to FIG. 9, a method for installing seal assembly 110 in an underground pipeline is shown. First, the seal 112 of seal assembly 110, having diameter D₁, shown in FIG. 7, is provided. Next, seal 112 is folded to a width W₁, as described above and as shown in FIG. 8. Then, manhole cover 41 is removed from manhole opening 45, as shown by arrow A₅, to provide an opening having a diameter D₂ for seal assembly 110 to be brought to its underground installation site. The diameter D₂ of the manhole opening 45 can be as little as about 18 inches, 20 inches, or 24 inches, and as large as about 48 inches, 60 inches, or 72 inches. Diameter D₂ is larger than width W₁, but may be smaller than diameter D₁. Thus, seal 112 having a diameter D₁, if greater than diameter D₂, will not fit and pass through manhole opening 45 with diameter D₂, and it is necessary for seal 112 to be folded to a width W₁, as described above. Seal assembly 110 is then passed through manhole opening 45 and into the manhole riser 49 along arrow A₆. Once a crack (not shown), or a defective joint 47 between pipes 40 and 42 is located, seal assembly 110 is passed further along arrow A₆ to its installation site. The inner diameter D₃ of pipes 40 and 42 is roughly equal to diameter D₁ of seal 112. The diameter D₃ of pipes 40 and 42 can be as little as about 12 inches, 15 inches, or 18 inches, and as large as about 72 inches, 96 inches, or 120 inches.

Once seal assembly 110 is brought to its underground installation site, seal 112 is placed within the pipes 40 and 42 such that one end sealing portion 114a is positioned adjacent spigot end 44 of pipe 40 and the other end sealing portion 114a is positioned adjacent socket end 46 of pipe section 42. The third, middle sealing portion 114b is positioned with sealing ridges 18 substantially centered about and bridging joint line 47 formed by and between pipes 40 and 42. Alternatively, seal assembly 110 may be positioned such that the third, middle sealing portion 114b is positioned with sealing ridges 18 substantially centered about and bridging a crack formed in a single pipe.

Once seal assembly 110 is positioned at its underground installation site, the three expansion mechanisms 28 are positioned in expansion band seats 20 and connected to expansion band ends 30a, thus completing assembly of the expansion band assemblies 26. Expansion band assemblies 26 may be, for example, of the type disclosed in U.S. Pat. Nos. 6,805,359 and 7,146,689, each assigned to the assignee of the present invention, the disclosures of which are expressly incorporated herein by reference. Each expansion band assembly 26 generally includes an expansion mechanism 28 operable to expand the diameter of expansion band 30 of the expansion band assembly 26 radially outwardly to compress a sealing portion 114 against the inner surface 50 of pipes 40 and 42. In particular, as best shown in FIG. 5 and discussed in the above-incorporated U.S. Pat. Nos. 6,805,359 and 7,146,689, each expansion mechanism 28 generally includes a bolt 32 having oppositely-threaded ends and a central nut 33. The oppositely-threaded ends of bolt 32 are threadingly received within a pair of oppositely-threaded block members 34 which are in engagement with expansion band ends 30a. In use, nut 33 of bolt 32 is engaged by a suitable tool to rotate bolt 32 and drive block members 34 apart from one another to thereby expand the diameter of expansion band 30 to radially outwardly compress a sealing portion 114 of seal 10 into tight engagement with the inner surface of a pipe. Thereafter, expansion mechanisms 28 of expansion band assemblies 26 are actuated in the manner described above to outwardly radially compress sealing portions 114 and their sealing ridges 18 of seal 112 into fluid tight sealing engagement with the inner surfaces 50 of pipes, respectively, thereby providing a fluid tight seal between pipes 40 and 42 and joint line 47.

Each expansion band assembly 26 includes at least two semi-circular expansion bands 30, each having end portions 30a and at least two expansion mechanisms 28, while sealing assemblies 110 for larger diameter pipes may include three or more expansion bands 30 and three or more expansion mechanisms 28, as needed.

Referring to FIG. 10, in the embodiments in which sealing portions 114 include thin wall sections 22, one or more slits 23 or windows 25 may be formed, or may be cut in the field, in wall sections 22 which allow for expansion bands 30 and expansion mechanisms 28 of expansion band assembly 26 to be slidably inserted within annular hollow sections 24. The slit 23 or window 25 may be disposed adjacent an expansion mechanism 28 to allow access to expansion mechanism 28 during or after installation to effect the seal as described above. Each slit 23 or window 25 may extend around only a portion of the circumference of its wall section 22, such as around as little as 5°, 10°, or 15°, or as great as 30°, 60°, 90° or more, for example, of the circumference of wall sections 22, or alternatively, may extend around the entire circumference of wall sections 22.

The adjacent portions 21a and 21b of thin wall sections 22 defined by slits 23 may be disposed in tight abutting end-to-end contact with one another, similar to the embodiment shown in FIG. 2A, for example, or may overlap one another, as shown in the embodiment of FIG. 10, for example, in order to minimize or prevent fluid entry into hollow sections 24. Further, similar to the embodiment shown in FIG. 3, the slits 23 may be optionally disposed on a side of sealing portions 114 opposite a direction of fluid flow along arrow A₁, such as at location 23a, for example, to minimize or prevent fluid entry into hollow sections 24. Also, the expansion mechanisms 28 may be positioned at the upper end of the pipes 40 and 42 which are normally above the fluid level of the pipes to prevent or eliminate fluid entry into hollow sections 24.

When sealing assembly 110 is positioned across joint line 47 between pipes 40 and 42, middle sealing portion 114b of seal 112 may directly sealingly engage about and bridge joint line 47. Middle sealing portion 114b may also directly sealingly engage about and bridge a crack in pipes 40 and 42. Due to this positioning, middle sealing portion 114b applies pressure directly to, and about, the joint line 47. This is advantageous in that middle sealing portion 114b will therefore prevent water, or any other liquid, from leaking into and/or building up and forming a pressurized space between the outer surface of sealing assembly 110 and the inner surfaces 50 of pipes 40 and 42, thus preventing any potential for the shifting of end sealing portions 114a of sealing assembly 110 along the inner surfaces of pipes 40 and/or 42, or other movement or distortion of end sealing portions 114a of sealing assembly 110.

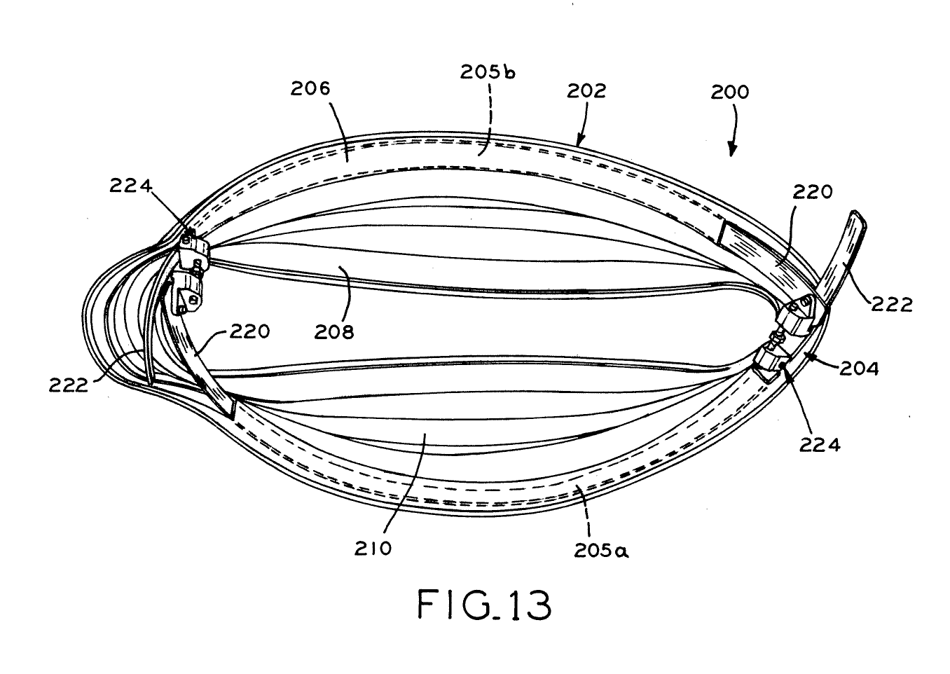

Referring now to FIG. 11, in another application the sealing assemblies described herein, such as sealing assemblies 10c, 110a, or 110b, may be installed in manhole riser 49 sealing a connection across joint lines 83, 84 formed between one or more grade rings 80 and/or manhole chimney 43 or manhole frame 92. Grade rings 80 are used to raise manhole frame 92 and its cover 41 to a position substantially flush with street surface 90. Sealing assembly 10c, 110a, or 110b may be prepared for installation and installed the same way as described above in the method for installing sealing assembly 110. However, in this instance, sealing assembly 10c, 110a, or 110b is brought to joint lines 83, 84 formed between grade rings 80 and manhole chimney 43, rather than to a crack or defective joint 47 between pipes 40 and 42. Once sealing assembly 10c, 110a, or 110b is brought to joint lines 83, 84 formed between grade rings 80 and manhole chimney 43, seal 12, 112 is positioned such that all joint lines 83, 84 between grade rings 80 and manhole chimney 43 and/or between grade ring 80 and manhole frame 92, are completely covered by seal assembly 10c, 110a, or 110b. This occurs when each end sealing portion 14, 114a is positioned adjacent grade rings 80 and manhole chimney 43. The remainder of the installation and the expansion of sealing assembly 10c, 110a, or 110b is performed as described above to provide a fluid tight seal across the inner surfaces 81 of grade rings 80 and the inner surface 82 of manhole chimney 43 and/or manhole frame 92, to prevent fluid infiltration into, or out of, manhole riser 49.

Although sealing assembly 10f, 110a, 110b are shown and described above, any other of the aforementioned sealing assemblies may be installed in manhole riser 49 to seal a connection across joint lines 83, 84 formed between grade rings 80 and manhole chimney 43. In an alternative embodiment, in cases where many grade rings 80 are utilized, sealing assembly 10c, 110a, 110b may be installed to seal a connection across joint lines 83 formed between each grade ring 80.

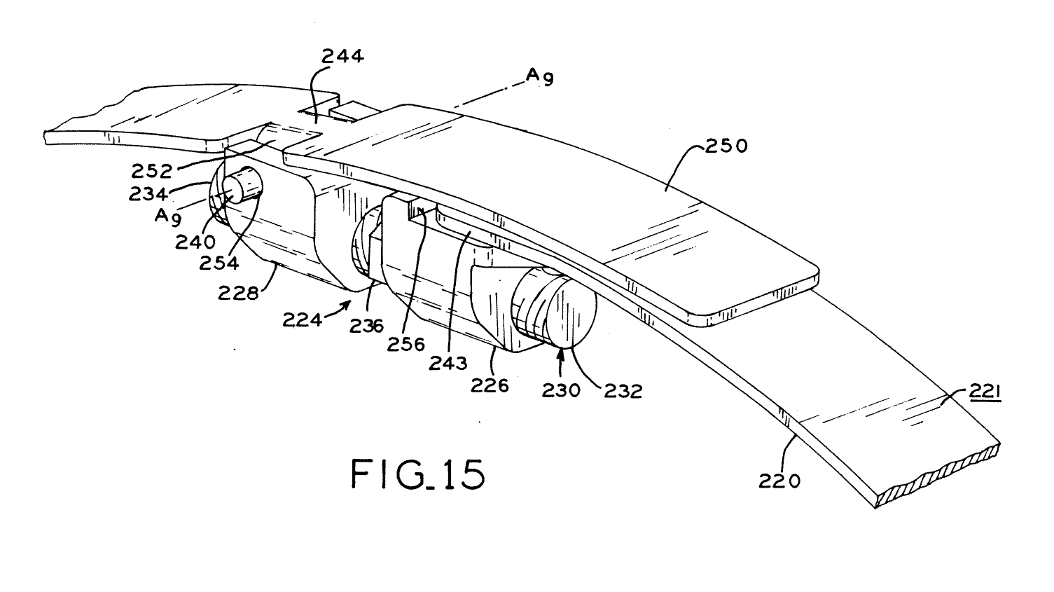

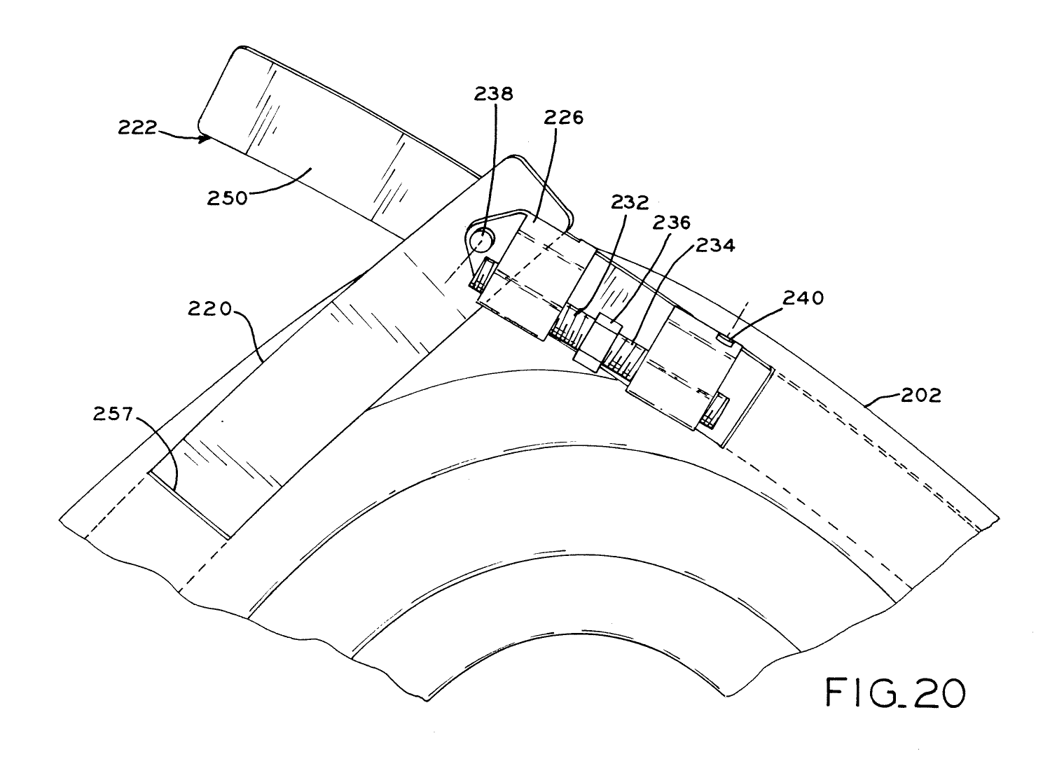

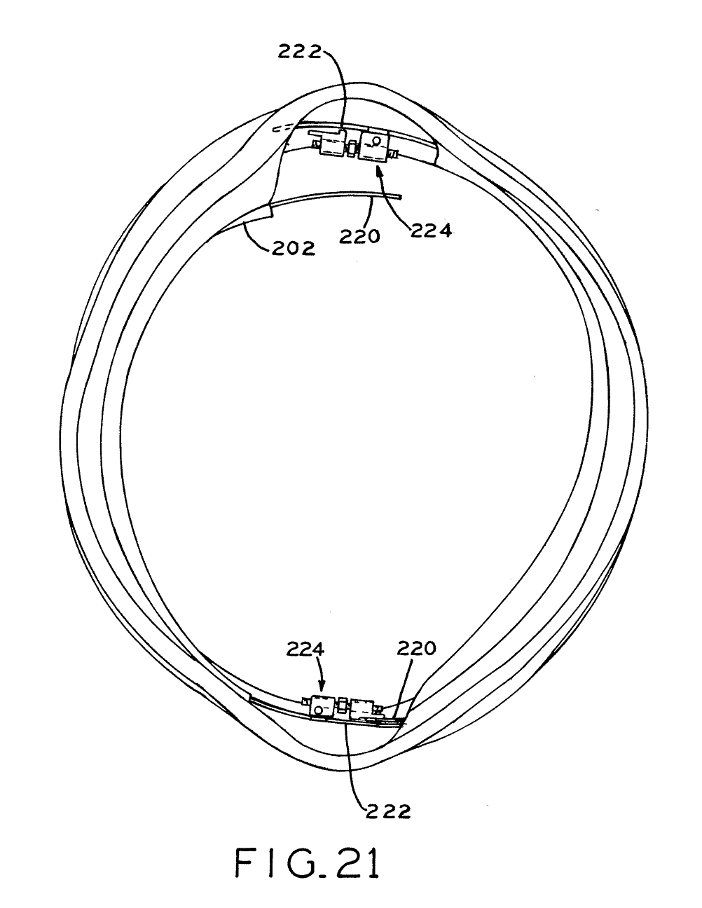

Turning now to FIGS. 13-22, sealing assembly 200 according to a further embodiment is shown which, except as described below, is installed and functions in the same manner as the embodiments discussed above.

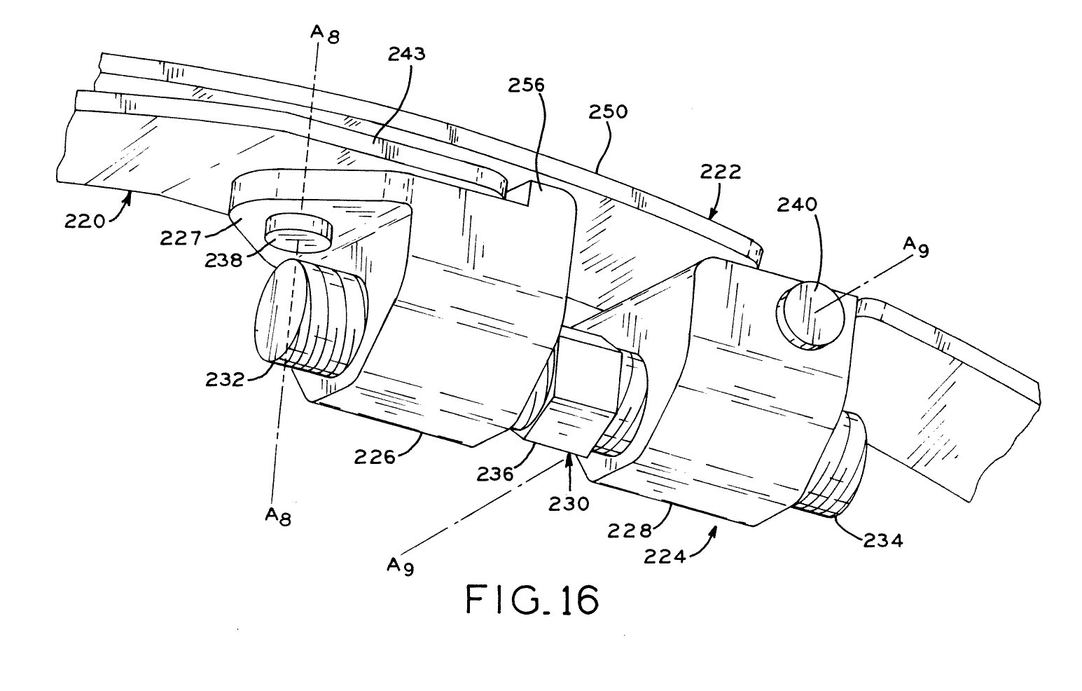

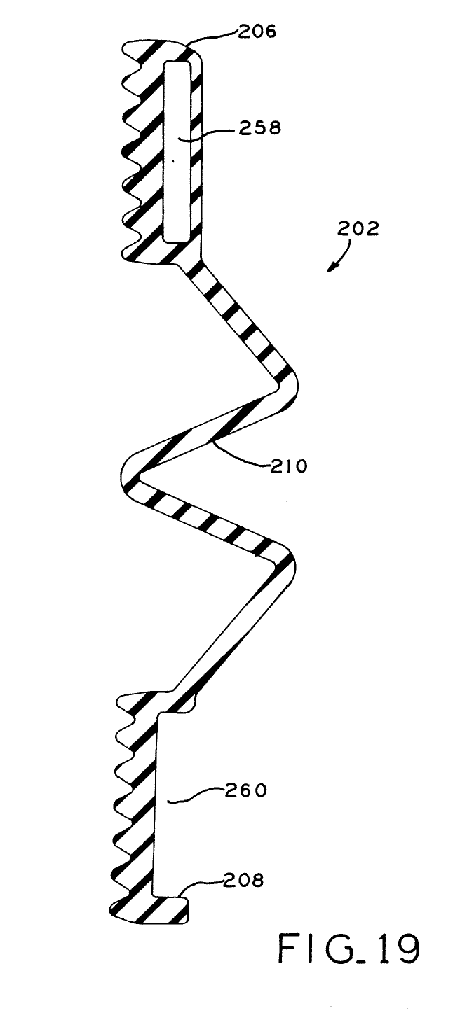

Referring initially to FIGS. 13 and 14, a collapsible pipe seal assembly 200 generally includes seal 202 and expansion band assembly 204. As shown in FIGS. 14 and 19, seal 202 includes upper seal portion 206 and lower seal portion 208, with upper and lower portions 206, 208 joined by bridge portion 210. Seal assembly 200 is adapted to sealingly engage with a generally annular rigid surface, such as the opening of an underground pipe system 212 (FIG. 14) in the exemplary manner described below.

For example, in the illustrated embodiment of FIG. 14, pipe system 212 includes rigid base 214, which is shown as a concrete structure and, in particular, a manhole riser or chimney. Rigid base 214 leads to an underground pipeline system, such as a sewer system or a fluid storage system. Grade rings or spacers 216 are received at an upwardly facing surface of base 214 to form one or more seams 215 therebetween. Spacers 216 are typically used to space frame 218 (shown in FIG. 14 as a frame sized and adapted to receive a manhole cover) upwardly from base 214, such as to align frame 218 at street grade. Frame 218, which is typically formed of a cast metal, is received upon an upwardly facing surface of spacer 216 to form seam 217 therebetween.

In some cases, seams 215, 217 may not be fluid-tight. Pipe seal assembly 200 may be installed adjacent to frame 218, spacers 216 and/or base 214 to prevent infiltration of liquid through the non-fluid tight seams 215, 217 from the surrounding environment. As shown in FIG. 14, pipe seal assembly 200 may be received within opening O so that seal 202 spans frame 218, risers 216, and base 214. As described in detail below, seal assembly 200 creates a barrier between seams 215, 217 and opening O to create a fluid-tight seal between the area about opening O and the surrounding subterranean environment. An exemplary seal is disclosed in U.S. patent application Ser. No. 12/409,656 filed Mar. 24, 2009, entitled INTERNAL PIPE SEAL and assigned to the assignee of the present invention, the disclosure of which is hereby expressly incorporated herein by reference in its entirety.

Referring additionally to FIGS. 13 and 15-18, expansion band assembly 204 includes identical first and second ring portions 205a, 205b joined by a pair of pivoting expansion mechanisms 224. Ring portions 205a, 205b are each semi-cylindrically shaped, i.e., are curved about 180° though generally half of a circular span, so that ring portions 205a, 205b can cooperate to form a generally circular, cylindrical assembly when configured to an unfolded configuration (described below). However, it is contemplated that ring portions 205a, 205b may be partially cylindrical to define any angular sweep, and that additional ring portions may be added to yield an assembly encompassing 360° in an unfolded configuration.

As shown in FIG. 13, ring portions 205a, 205b each include first ring end portion 220 and an opposite second ring end portion 222. Ring end portions 220, 222 of ring portions 205a, 205b are joined by adjustable expansion/pivot mechanisms 224 to form expansion band assembly 204, which is can be configured into a generally non-circular, non-cylindrical collapsed or folded configuration and a generally circular, cylindrical deployed or unfolded configuration, as described in detail below.

Referring still to FIG. 13, the two ring portions 205a and 205b are identical to one another and oppositely-oriented. Thus, at one end of assembly 204 (i.e., the left end as shown in FIG. 13), first ring end portion 220 of ring portion 205a is pivotally connected to second ring end portion 222 of the other ring portion 205b. Similarly, at the other end of assembly 204 (i.e., the right end as shown in FIG. 13), second ring end portion 222 of ring portion 205a is pivotally connected to first ring end portion 220 of the other ring portion 205b.

In an alternative embodiment, ring portions 205a, 205b may not be identical to one another. For example, both ends of ring portion 205a may comprise first ring end portions 220, while both ends of ring portion 205b may comprise second ring end portions 222. In this alternative embodiment, ring portions 205a and 205b are still pivotally connected to one another in a similar manner as shown in FIG. 13 in a similar manner. In another alternative embodiment, expansion band assembly 204 may include more than two ring portions 205a, 205b, such as four ring portions with four pivot/expansion mechanisms 224, such that multiple pivot points for folding are provided. Each of these configurations is operable in the manner described herein.

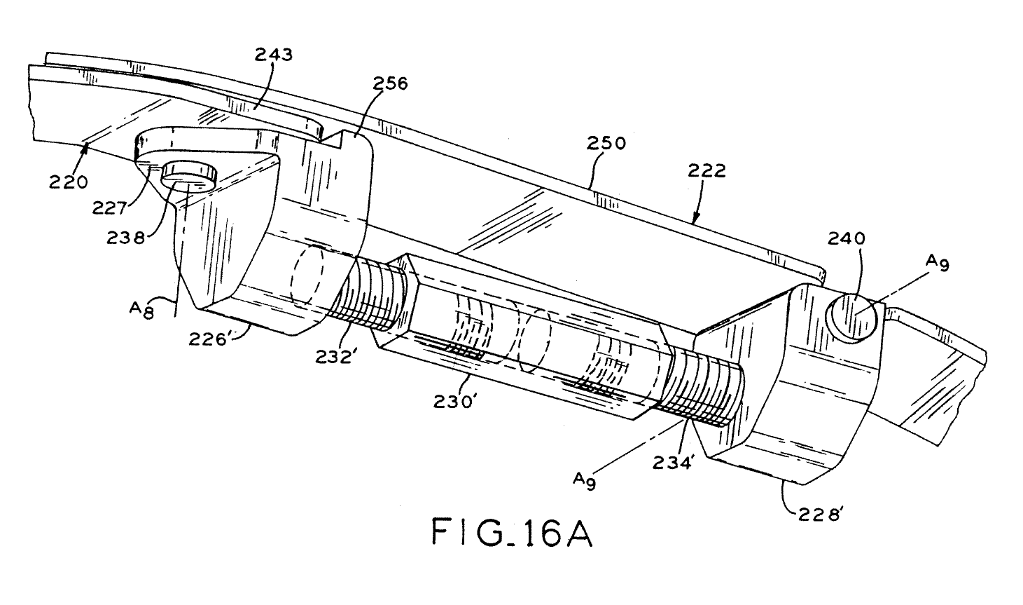

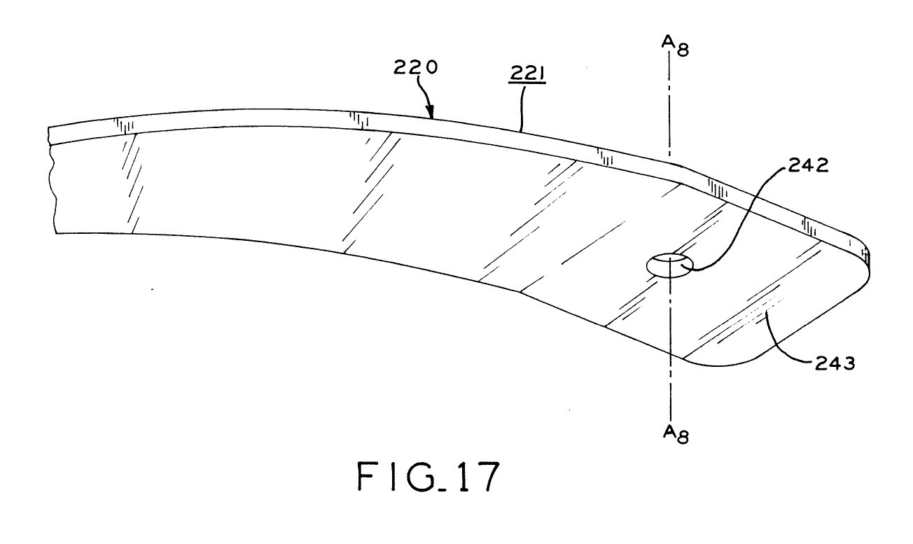

As best seen in FIGS. 15 and 16, expansion mechanism 224 includes first block 226 and second block 228, which are joined by adjuster 230. In the illustrative embodiment shown, adjuster 230 is a bolt with oppositely-threaded ends 232, 234 and central nut 236. Exemplary adjusters are disclosed in U.S. Pat. Nos. 6,805,359 and 7,146,689, each incorporated by reference above. As described in detail below, expansion band assembly 204 uses expansion/pivot mechanisms 224 both to pivotably connect ring portions 205a, 205b, as well as to expand expansion band assembly 204 by selectively spreading ring portions 205a, 205b apart.

Adjuster 230 of expansion mechanism 224 is threadingly received within blocks 226, 228 so that first threaded end 232 engages with block 226 and the second, oppositely threaded end 234 engages with block 228. Nut 236 is disposed between and coupled to first end 232 and second end 234, so that rotation of nut 236 correspondingly rotates ends 232, 234. Because first and second ends 232, 234 are oppositely threaded, rotation of adjuster 230 (i.e., via nut 236) results in blocks 226, 228 moving either away from each other or toward one another depending on the direction of rotation. When expansion band assembly 204 is in the generally circular, unfolded configuration (FIG. 13) and blocks 226, 228 are moved away from each other, the diameter of assembly 204 expands to radially outwardly. This outward expansion compresses the portion of seal 202 that is adjacent assembly 204, i.e., upper seal portion 206 or lower seal portion 208, into tight or sealing engagement with the adjacent annular surface, as discussed in detail below.

In an alternative embodiment, the threaded engagement between blocks 226, 228 and adjuster 230 may be reversed. As shown in FIG. 16A, for example, blocks 226′, 228′ may be provided having oppositely-threaded studs 232′, 234′ extending therefrom, respectively. Studs 232′, 234′ are received by oppositely-threaded apertures at each end of adjuster 230′. Thus, rotating adjuster 230′ spreads apart or draws together blocks 226′, 228′ via studs 232′, 234′, depending on the direction of rotation. Moreover, it is contemplated that any type of threaded engagement may be utilized to expand or contract an expansion band assembly in accordance with the present disclosure.

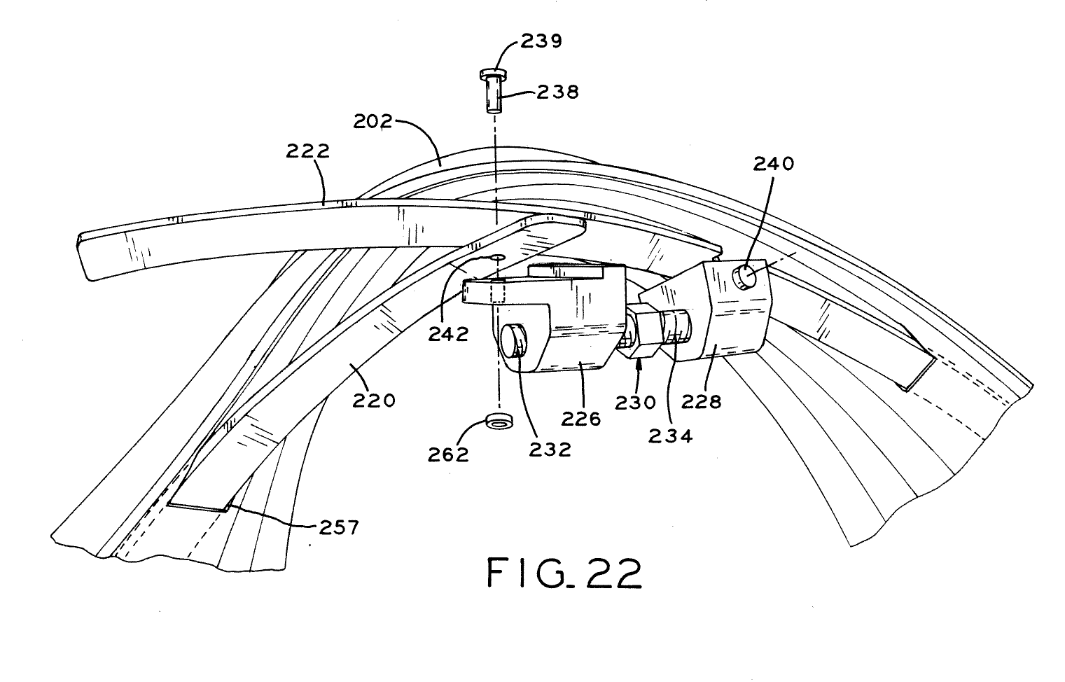

As shown in FIGS. 16, 20 and 22, first block 226 of expansion mechanism 224 is pivotably attached to an ring end portion 220 by fastener 238, with such connected adapted to allow rotation of block 226 with respect to ring end portion 220. In an exemplary embodiment, fastener 238 is a fastener having a smooth outer cylindrical surface to facilitate such rotation, with fastener 238 held in place by a swaged or otherwise enlarged head portion 239 at one end and nut 262 at the other end (FIG. 22). However, fastener 238 may be any suitable fastener that allows pivoting motion between block 226 and ring end portion 220, such as a bolt, rivet or pin for example. Block 226 rotates with respect to fastener 238 about pivot axis A₈ (FIG. 16), which is generally perpendicular to central axis A₇ of expansion band assembly 204 (FIG. 14). Axis A₈ may intersect or run askew from central axis A₇ of expansion band assembly 204.

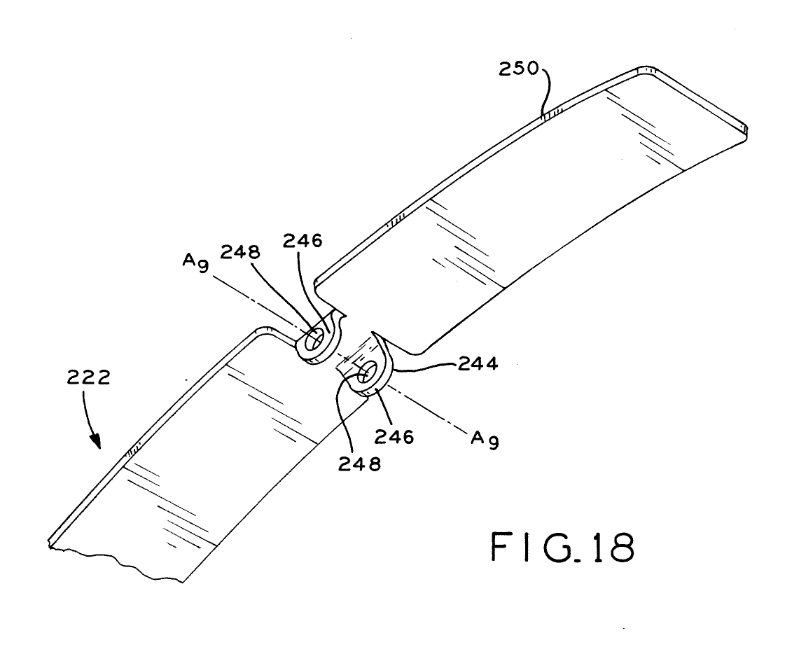

Referring to FIG. 17, ring end portion 220 of ring portions 205a, 205b includes aperture 242 formed therein. When ring end portion 220 is attached to block 226 via fastener 238, aperture 242 is coincident with pivot axis A₈. Aperture is formed in flattened portion 243 of ring end portion 220, which mates with the correspondingly flat face of flange 227 (FIG. 16) formed in block 226. To join block 226 to end portion 220, flange 227 includes an aperture (not shown) located and sized to align with aperture 242 and receive fastener 238.

As best seen in FIGS. 15 and 16, second block 228 of expansion mechanism 224 is pivotably attached to ring end portion 222 by fastener 240, such that rotation of block 228 with respect to ring end portion 222 is permitted. As shown in FIG. 18, ring end portion 222 includes an integral, monolithically formed clevis 244, which may be created by cutting and bending material from the body of ring end portion 222. Clevis 244 includes legs 246 having apertures 248, with apertures 248 substantially aligned with one another. Block 228 includes opening 252 sized and positioned to receive clevis 244. Apertures 254 pass through the body of block 228 into opening 252, and are sized and positioned to align with apertures 248 of ring end portion 222.

More particularly, when ring end portion 222 is assembled with second block 228 (FIG. 15), apertures 248, 254, respectively, receive fastener 240 to pivotably secure ring end portion 222 to block 228 about axis A₉ (FIGS. 15 and 16). In an exemplary embodiment, fastener 240 has a smooth outer cylindrical surface, and is held in place by a swaged or otherwise enlarged head portion at one end and nut at the other end, similar to fastener 238 used to rotatably secure block 226 to end portion 220 as described above. However, fastener 240 may be any other suitable fastener that allows pivoting motion between block 228 and ring end portion 222, including a permanent fastener such as a rivet.

During use of assembly 204, a relatively small rotation or pivoting of block 228 with respect to ring end portion 222 occurs about pivot axis A₉, which is the common axis of apertures 248, fastener 240 and apertures 254 formed in block 228. Pivot axis A₉ is generally parallel to central axis A₇ of expansion band assembly 204, and generally perpendicular to pivot axis A₈ of aperture 242 formed in block 226. When ring portions 205a, 205b are pivoted with respect to one another about pivot axis A₈, a relatively large angular movement may occur, such as up to 180 degrees. During such movement, and depending on the particular arrangement of expansion band assembly 204, some angular movement of end portions 220, 222 with respect to one another may also occur. Pivot axis A₉ accommodates this movement and therefore facilitates smooth motion of ring portions 205a, 205b between the collapsed and deployed configurations. However, it is contemplated that blocks 228 may be rigidly coupled to ring end portions 222, such that any movement that would have been accommodated by pivoting about pivot axis A₉ is instead accommodated by slight material deflection in one or both of ring portions 205a, 205b.

Ring end portion 222 further includes overlap portion 250, which extends beyond clevis 244 to the end of ring end portion 222. Overlap portion 250 of ring end portion 222 ensures that pressure is evenly distributed against seal 202 in the region of expansion mechanism 224 during operation of the device. More particularly, when adjusters 230 are rotated to increase pressure between expansion band assembly 204 and an adjacent annular surface, overlap portion 250 is disposed between outer surface 221 of ring end portion 220 (FIGS. 15 and 17) and seal 202. Thus, overlap portion 250 prevents seal 202 from directly contacting the components of expansion mechanism 224, and ensures that expansion band assembly 204 presents a substantially continuous outer ring surface (i.e., the outer surfaces of ring portions 205a, 205b) for contact with seal 202. To further enhance the even distribution of pressure forces from assembly 204 to seal 202, block 226 may include shoulder 256 (FIGS. 15 and 16) extending toward ring end portion 222, such that shoulder 256 further distributes pressure exerted on ring end portion 222 in the region of expansion mechanism 224.

When expansion band assembly 204 is in service, assembly 204 is disposed in a deployed, opened, or unfolded configuration shown in FIG. 14. In this deployed configuration, ring portions 205a, 205b form a generally cylindrical or circular profile of expansion band assembly 204 having outer diameter D (FIG. 14). Expansion band assembly 204 may be pivoted about pivot axis A₈ in the manner described above and shown in FIGS. 13, 20, 25, and 26 into an undeployed, closed, or folded position, in which ring portions 205a, 205b are disposed at an angle with respect to one another. In the undeployed position, expansion band assembly 204 has a reduced profile that may be easily passed through an opening, such as opening O (FIG. 14) of an underground structure and, once positioned therein, may be opened or unfolded into the deployed position in which expansion band assembly 204 substantially corresponds with the size of the opening in which it is received.

Expansion band assembly 204 may be installed into seal 202 to create pipe seal assembly 200, as shown in FIG. 13. More specifically, expansion band assembly 204 may be captured within seal 202 by passing each of ring portions 205a, 205b through windows 257 (FIG. 14, which may optionally be in the form of slits, such as slits 23 described above) into partially annular tunnels or slots 258 (FIG. 19) of seal 202. Respective ring end portions 220, 222 are then joined by affixing expansion mechanisms 224 thereto, as shown in FIG. 22 and described above.

Once expansion band assembly 204 is captured within slots 258 of seal 202, collapsing or folding expansion band assembly 204 to a folded configuration also collapses or folds seal 202. Thus, while pipe seal assembly 200 in the resulting undeployed position (FIG. 13), assembly 200 may be passed through opening O (FIG. 14) with little or no interference. Once received within the underground structure, pipe seal assembly 200 can be opened or unfolded by configuring expansion band assembly 204 to the unfolded configuration, as shown in FIG. 14. Expansion band assembly 204 can then be expanded by turning adjuster 230 to move blocks 226, 228 away from one another, thereby expanding the effective diameter of expansion band assembly 204 and urging upper portion 206 of seal 202 against the adjacent annular surface, such as the surfaces of frame 218 and risers 216 as shown in FIG. 14. Once this sealing step is completed, the initial installation of pipe seal assembly 200 is complete.

With upper portion 206 of seal 202 now secured within opening O, a second expansion band assembly 204 may be passed into opening O in its folded or undeployed position for securement of the lower portion of pipe seal assembly 200 to the adjacent annular wall. Lower portion 208 of seal 202 includes groove 260, which is sized to receive expansion band assembly 204. Unlike slot 258 at upper seal portion 206, groove 260 is open, so that expansion band assembly 204 need not be disassembled to pass ring portions 205a, 205b into groove 260. Thus, with a folded expansion band assembly 204 received within opening O, expansion band assembly 204 may be fitted within groove 260 and moved to its opened or deployed position to seat assembly 204 to lower portion 208 of seal 202. Adjuster 230 may then be turned to move blocks 226, 228 away from one another, thereby expanding the lower expansion band assembly 204 and urging lower seal portion 208 against the adjacent annular surface, such as the inner surface of base 214 as shown in FIG. 14.

Advantageously, the closed profile of slot 258 and the ability to fold pipe seal assembly 200 allows pipe seal assembly 200 to be installed into opening O by a single installer. Specifically, seal 202 need not be held in place by one installer while a second installer installs expansion band assembly 204 at upper portion 206. Also, since the lower expansion band assembly 204 need not be installed at lower seal portion 208 until after the upper expansion band assembly 204 has been secured, one installer can secure lower seal portion 208 after upper portion 206 is already firmly secured. Thus, there is no need for a second installer to hold pipe seal assembly 200 in place while a second, lower expansion band assembly 204 is installed.

Although seal 202 is described as being a single unitary seal above, a plurality of seals may be used in conjunction with a plurality of expansion band assemblies to seal openings with large inner annular surfaces, and/or several seams. For example, an extension seal (not shown) may be installed to seal 202, with the extension seal having an upper seal portion sized to fit within groove 260 so that the lower expansion band assembly and seal 202 engages both the lower seal portion 208 of seal 202 and the upper seal portion of the extension seal (not shown). The extension seal may then have a lower seal portion similar to lower seal portion 208. In an exemplary embodiment, extension seals may be used where the vertical distance to be sealed exceeds approximately 10 inches.

Although sealing assembly 200 is shown and described above in an application in which same is used to provide a seal at the upper end of an underground structure, such as providing a seal between a manhole chimney and a manhole frame, sealing assembly 200 may also be used to provide a seal across a pipe joint in the manner described above and shown in FIGS. 1, 3 and 5.

While this invention has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A sealing assembly comprising:
a cylindrical seal; and
an expansion band assembly, comprising:
a pair of partially-cylindrical ring portions each having opposing first and second end portions; and
a pair of expansion mechanisms, each said expansion mechanism comprising:
threaded first and second block members having first threads, said first block members each pivotally connected to a respective first end portion of said ring portions to define a pivot axis; and
a bolt having second threads adapted to cooperate with said first threads of said first and second block members, rotation of said bolt in a first direction causing said block members to be simultaneously driven apart from one another to expand said expansion band,
said ring portions pivotable with respect to one another about said pivot axes of said pair of expansion mechanisms, wherein said expansion band assembly defines a deployed configuration in which said pair of ring portions cooperate to define a substantially cylindrical shape defining an expansion band assembly diameter, and said expansion band assembly defines a collapsed configuration in which said pair of ring portions have a reduced profile smaller than said diameter.

2. The sealing assembly of claim 1, wherein said expansion band assembly defines a central axis in said deployed condition, said pivot axis substantially normal to said central axis.

3. The sealing assembly of claim 1, wherein said expansion band assembly defines a central axis in said deployed condition, at least one of said second blocks pivotally connected to one of said second end portions of said ring portions to define a second pivot axis, said second pivot axis substantially parallel to said central axis.

4. The sealing assembly of claim 1, wherein said first threads comprise threaded bores through each of said first and second block members, and said second threads comprise oppositely-threaded ends of said bolt, said oppositely-threaded ends respectively threaded within said threaded bores of said first and second block members.

5. The sealing assembly of claim 1, wherein said first end portions of said ring portions overlap said second ends thereof when said expansion band assembly is in said deployed configuration, wherein said first end portions are disposed between said expansion mechanisms and said cylindrical seal.

6. The sealing assembly of claim 1, wherein said cylindrical seal includes a slot sized to receive said ring portions of said expansion band assembly, at least one of said ring portions at least partially captured within said slot.

7. The sealing assembly of claim 6, wherein said ring expansion mechanism are disposed outside said slot.

8. The sealing assembly of claim 6, further comprising:
a second sealing assembly,
said cylindrical seal including a groove spaced from said slot, said groove sized to receive said expansion band assembly, said sealing assembly received in said groove.

9. A sealing assembly comprising:
a cylindrical seal;
first and second ring portions at least partially captured within said cylindrical seal, each of said first and second ring portions comprising a first end portion having a first aperture formed therethrough, said aperture defining a first pivot axis;
connecting means for pivotably connecting said first end portions of said first and second band portions to said second end portions thereof, wherein the sealing assembly is configurable in deployed and collapsed configurations, said collapsed configuration having a reduced profile as compared to said deployed configuration; and
expansion means for expanding a diameter of the sealing assembly when in said deployed configuration.

10. A sealing assembly of claim 9, wherein said first and second band portions each further comprise a second end portion including a clevis having a second aperture formed therethrough, said second aperture defining a second pivot axis substantially normal to said first pivot axis.

11. The sealing assembly of claim 10, wherein the sealing assembly defines a central axis in said deployed condition, said second pivot axis substantially parallel to said central axis.

12. The sealing assembly of claim 9, wherein the sealing assembly defines a central axis in said deployed condition, said first pivot axis substantially perpendicular to said central axis.

13. The sealing assembly of claim 9, wherein both said connecting means and said expansion means comprise a pair of expansion mechanisms.

14. The sealing assembly of claim 9, wherein said connecting means comprises a pair of expansion mechanisms, each said expansion mechanism comprising:
first and second block members, said first block members each pivotally connected to said aperture formed in said first end portions of said first and second ring portions; and
adjusting means coupled to said first and second block members, said adjusting means for simultaneously driving said first and second block members apart from one another to expand said expansion band.

15. The sealing assembly of claim 9, wherein said expansion means comprises a pair of expansion mechanisms, each said expansion mechanism comprising:
first and second block members, said first block members each pivotally connected to said aperture formed in said first end portions of said first and second ring portions; and
adjusting means coupled to said first and second block members, said adjusting means for simultaneously driving said first and second block members apart from one another to expand said expansion band.

16. A method of sealing an annular wall including:
providing a sealing assembly, the sealing assembly comprising:
a cylindrical seal including at least one annular sealing portion, the sealing portion including an expansion band seat; and
a pair of expansion band ring portions at least partially captured within the expansion band seat, the expansion band ring portions each having first and second end portions, the first end portions pivotably connected to the second end portions about a pair of pivot axes;
folding the sealing assembly by pivoting the expansion band ring portions into a generally non-cylindrical configuration about the pivot axes, said step of unfolding placing the sealing assembly in a collapsed configuration;
placing the sealing assembly adjacent an annular inner wall of a cylindrical structure;
unfolding the sealing assembly by pivoting the expansion band ring portions into a generally cylindrical configuration, said step of unfolding placing the sealing assembly in a deployed configuration; and
expanding the expansion band ring portions with respect to one another to compress the cylindrical seal against the annular inner wall of the cylindrical structure.

17. The method of claim 16, wherein the sealing assembly further comprises a pair of expansion mechanisms, each expansion mechanism comprising:
first and second block members each having a threaded bore therethrough, the first block members each pivotally connected to a respective first end portion of the expansion band ring portions to define one of the pivot axes; and
a bolt including oppositely-threaded ends respectively threaded within the threaded bores of the first and second block members.

18. The method of claim 17, wherein said step of expanding the expansion band ring portions comprises rotating the bolt in a first direction, said step of rotating the bolt causing the block members to be simultaneously driven apart from one another to expand the expansion band ring portions.

19. The method of claim 17, wherein each of the second block members are rotatably coupled to the second end portions of the expansion band ring portions about a second pivot axis, the first pivot axes substantially normal to the second pivot axes, said steps of folding and unfolding the sealing assembly comprising pivoting the first and second block members about the first and second pivot axes.

20. The method of claim 16, wherein the sealing assembly further comprises providing a second pair of expansion band ring portions each having first and second end portions, the first end portions pivotably connected to the second end portions about a pair of pivot axes in similar fashion to the pair of expansion band ring portions at least partially captured within the expansion band seat, the method further comprising:
pivoting the second pair of expansion band ring portion into a collapsed configuration;
placing the second pair of expansion band ring portions adjacent the cylindrical seal of the sealing assembly, the second pair of expansion band ring portions spaced from the pair of expansion band ring portions at least partially captured within the expansion band seat;
pivoting the second pair of expansion band ring portions into a generally cylindrical configuration, said step of unfolding placing the sealing assembly in a deployed configuration; and
expanding the expansion band ring portions with respect to one another to compress a second portion of the cylindrical seal against the annular inner wall of the cylindrical structure.
